(19) United States
(12) Patent Application Publication
(10) Pub. No.: US 2013/0231967 A1
(43) Pub. Date: Sep. 5, 2013

(54) STRUCTURED COMMUNICATION FOR AUTOMATED DATA GOVERNANCE

(71) Applicants: Thomas D. Jesionowski, Port Orchard, WA (US); Sri Ramanathan, Lutz, FL (US); Jean-Gael Fabien Reboul, Kenmore, WA (US)

(72) Inventors: Thomas D. Jesionowski, Port Orchard, WA (US); Sri Ramanathan, Lutz, FL (US); Jean-Gael Fabien Reboul, Kenmore, WA (US)

(73) Assignee: INTERNATIONAL BUSINESS MACHINES CORPORATION, Armonk, NY (US)

(21) Appl. No.: 13/411,288

(22) Filed: Mar. 2, 2012

(51) Int. Cl. G06Q 10/00

(52) U.S. Cl. 705/7.11

(57) ABSTRACT

The invention is directed to a communication flow for automated data governance. A structured communication model defines and manages information flow between data governance stakeholders (DGS) to provide an integrated workflow leveraging multiple data integration applications. The communication model defines the roles and responsibilities of each DGS, and governs information flow from a source application, through a shared data repository, and onward to multiple reporting environments. The process interacts with middle-ware to manage various aspects of metadata such as the context and meaning of terms and data within systems to enable automated data governance according to the communication model.

### TECHNICAL FIELD

This invention relates generally to data governance in a business information technology (IT) environment, and more specifically, to governance via a structured communication process flow.

### BACKGROUND

Today's IT business environment, with its complexity, required quick responses, and globalization, requires significant costs to an organization or enterprise to stay competitive and meet business initiatives and challenges. For example, an enterprise might encounter some of the following challenges and business problems: global competition, product development costs, regulatory compliance, lack of skilled staff, new business opportunity, etc. While addressing any or all of these areas, the enterprise must be certain that the value of the business internally and the value provided to its customers are maintained or improved. This causes businesses to focus on how to structure, sustain, grow, transform, and manage the enterprise to meet these challenges, including the corporate policies, processes, and IT infrastructure and systems that are required.

Often these challenges and business problems are addressed through governance processes, which attempt to strategically align elements of the business and IT. In general, IT governance provides an approach in which leadership accomplishes the delivery of important business capability using IT strategy, goals and objectives. IT governance focuses on strategic alignment between the goals and objectives of the business and the utilization of its IT resources to effectively achieve the desired results. IT governance disseminates authority to the various layers in the organizational structures within the business, while ensuring appropriate and prudent use of that authority.

However, in today's IT environment the amount of data is exponentially growing. IT governance requires that data must be captured, stored, analyzed, and leveraged by business users to act on, and in particular, to react quickly and take the most efficient and informed decisions to drive the business towards success. Although this increased volume of data can help business users to gain insight into their customers, suppliers, competitors and organizations, it unfortunately augments the challenges and risks of managing and sharing the information through business systems. Enabling business users to react quickly and efficiency requires that large amounts of data must flow from the source systems to operational or analytics reporting systems. However, current approaches lack a secured, performant, and consistent manner to transform source data into reliable and trusted information that the business users can rely on to make their necessary business decisions.

### SUMMARY

In general, embodiments of the invention provide an approach for structuring communication to automate data governance. Embodiments include a structured communication model for managing information flow between defined data governance stakeholders (DGS) to provide an integrated workflow leveraging multiple data integration applications. The communication model defines the roles and responsibilities of each DGS, and governs information flow from a source application, through a shared data repository, and onward to multiple reporting environments. The process interacts with middle-ware to manage various aspects of metadata, such as the context and meaning of terms and data within automated systems, to provide automated data governance according to the communication model.

One aspect of the present invention includes a method for structuring communication to automate data governance, comprising the computer implemented steps of: identifying a set of data governance stakeholders (DGS) of a business process; providing a communication model defining a set of communication flows to adjacent stakeholders for each of the set of DGS; receiving a request to analyze business data of the business process; and assigning a set of functional roles to each of the DGS to analyze the business data according to the communication model.

Another aspect of the present invention provides a system for structuring communication to automate data governance comprising: a memory medium comprising instructions; a bus coupled to the memory medium; and a processor coupled to a data governance process orchestrator (DGPO) via the bus that when executing the instructions causes the system to: identify a set of data governance stakeholders (DGS) of a business process; provide a communication model defining a set of communication flows to adjacent stakeholders for each of the set of DGS; receive a request to analyze business data of the business process; and assign a set of functional roles to each of the DGS to analyze the business data according to the communication model.

Another aspect of the present invention provides a computer-readable storage device storing computer instructions, which when executed, enables a computer system to provide structured communication for automated data governance, the computer instructions comprising: identifying a set of data governance stakeholders (DGS) of a business process; providing a communication model defining a set of communication flows to adjacent stakeholders for each of the set of DGS; receiving a request to analyze business data of the business process; and assigning a set of functional roles to each of the DGS to analyze the business data according to the communication model.

Another aspect of the present invention provides a computer implemented method for structuring communication to automate data governance comprising: providing a computer infrastructure operable to: identify a set of data governance stakeholders (DGS) of a business process; provide a communication model defining a set of communication flows to adjacent stakeholders for each of the set of DGS; receive a request to analyze business data of the business process; and assign a set of functional roles to each of the DGS to analyze the business data according to the communication model.

### BRIEF DESCRIPTION OF THE DRAWINGS

FIG. 1 shows a schematic of an exemplary computing environment in which elements of the present invention may operate;

FIG. 2; shows a process flow for structuring communication to automate data governance according to embodiments of the invention;

FIG. 3 shows a process flow for structuring communication to automate data governance according to embodiments of the invention;

FIG. 4 shows an architecture in which a data governance process orchestrator operates according to embodiments of the invention;

FIG. 5 shows a process flow for structuring communication to automate data governance according to embodiments of the invention;

FIG. 6 shows a process flow for structuring communication to automate data governance according to embodiments of the invention; and

FIG. 7 shows a process flow for structuring communication to automate data governance according to embodiments of the invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Exemplary embodiments now will be described more fully herein with reference to the accompanying drawings, in which exemplary embodiments are shown. Embodiments of the invention provide a structured communication model for managing information flow between defined data governance stakeholders (DGS) to provide an integrated workflow leveraging multiple data integration applications. The communication model defines the roles and responsibilities of each DGS, and governs information flow from a source application, through a shared data repository, and onward to multiple reporting environments. The process interacts with middle-ware to manage various aspects of metadata such as the context and meaning of terms and data within systems to enable automated data governance according to the communication model.

This disclosure may, however, be embodied in many different forms and should not be construed as limited to the exemplary embodiments set forth herein. Rather, these exemplary embodiments are provided so that this disclosure will be thorough and complete and will fully convey the scope of this disclosure to those skilled in the art. The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Reference throughout this specification to “one embodiment,” “an embodiment,” “embodiments,” or similar language means that a particular feature, structure, or characteristic described in connection with the embodiment is included in at least one embodiment of the present invention. Thus appearances of the phrases “in one embodiment,” “in an embodiment,” “in embodiments” and similar language throughout this specification may, but do not necessarily, all refer to the same embodiment.

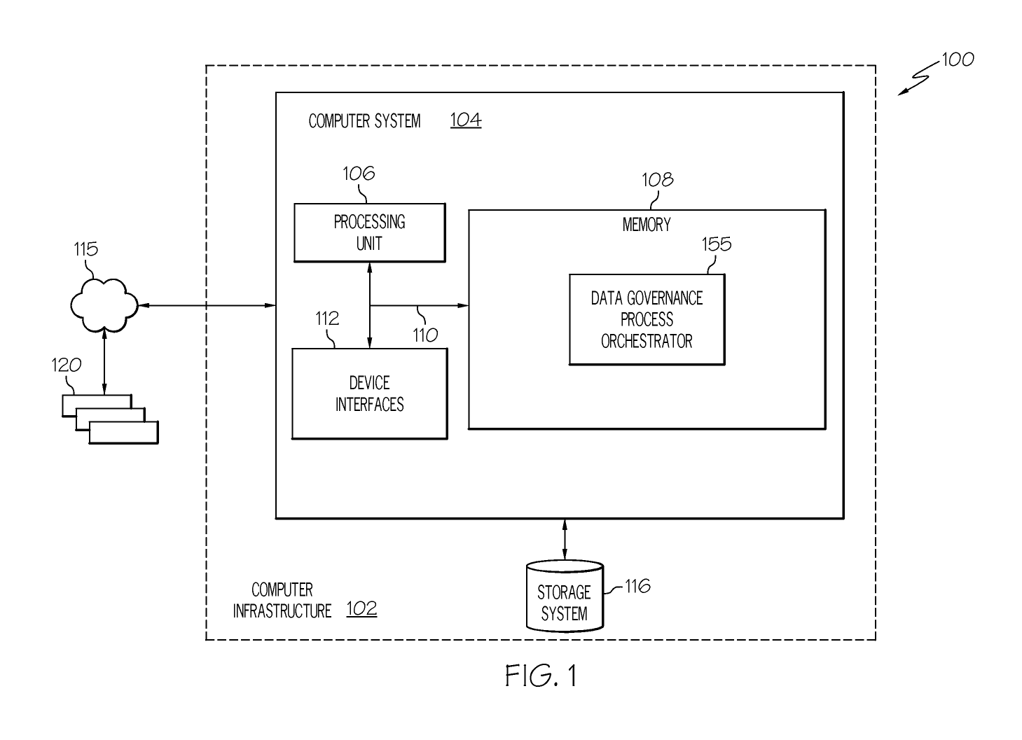

Turning now to FIG. 1, a computerized implementation 100 of the present invention will be described in greater detail. As depicted, implementation 100 includes computer system 104 deployed within a computer infrastructure 102. This is intended to demonstrate, among other things, that the present invention could be implemented within network environment 115 (e.g., the Internet, a wide area network (WAN), a local area network (LAN), a virtual private network (VPN), etc.), or on a stand-alone computer system. Still yet, the computer infrastructure of computer infrastructure 102 is intended to demonstrate that some or all of the components of implementation 100 could be deployed, managed, serviced, etc., by a service provider who offers to implement, deploy, and/or perform the functions of the present invention for others.

Computer system 104 is intended to represent any type of computer system that may be implemented in deploying/realizing the teachings recited herein. In this particular example, computer system 104 represents an illustrative system for providing structured communication to manage business data. It should be understood that any other computers implemented under the present invention may have different components/software, but will perform similar functions. As shown, computer system 104 includes a processing unit 106 capable of operating with a data governance process orchestrator (hereinafter “orchestrator”) 155 stored in a memory unit 108 to provide increased interoperability between hardware functions and web-based applications, as will be described in further detail below. Also shown is a bus 110, and device interfaces 112.

Processing unit 106 refers, generally, to any apparatus that performs logic operations, computational tasks, control functions, etc. A processor may include one or more subsystems, components, and/or other processors. A processor will typically include various logic components that operate using a clock signal to latch data, advance logic states, synchronize computations and logic operations, and/or provide other timing functions. During operation, processing unit 106 collects and routes data from a set of requests to analyze business data 120 (e.g., a request to define a new data element, perform an impact analysis, perform a root cause analysis, perform an audit request, etc.) to orchestrator 155. The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different systems may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)).

In general, processing unit 106 executes computer program code, such as program code for operating orchestrator 155, which is stored in memory 108 and/or storage system 116. While executing computer program code, processing unit 106 can read and/or write data to/from memory 108 and storage system 116. Storage system 116 can include VCRs, DVRs, RAID arrays, USB hard drives, optical disk recorders, flash storage devices, and/or any other data processing and storage elements for storing and/or processing data. Although not shown, computer system 104 could also include I/O interfaces that communicate with one or more hardware components of computer infrastructure 102 that enable a user to interact with computer system 104 (e.g., a keyboard, a display, camera, etc.).

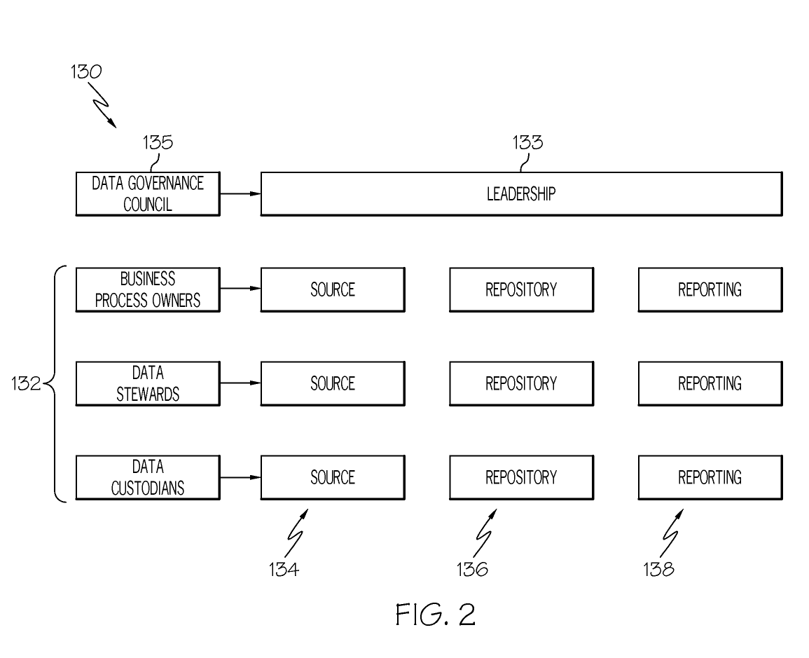

Turning now to FIG. 2, a communication model 130 defining an information flow according to embodiments of the invention is shown. As illustrated, the communication model 130 comprises a set of data governance stakeholders (DGS) 132 (e.g., business process owners, data stewards, data custodians) structured for information flow traversing from a set of source stakeholders 134 to a set of repository stakeholders 136 to a set of reporting stakeholders 138. Communication model 130 provides the key functional roles involved in defining and managing the data leveraged by the following DGS 132:

Business Process Owners define processes and actions needed to successfully conduct the business functions and make business decisions. Those business processes apply the business terms and data elements defined by data stewards.

Data Stewards are keepers of the business term and data element definitions used by business processes and the enterprise data models used by data custodians.

Data Custodians (an IT role) store, and move the data defined by Data Stewards and used by Business Process Owners. They ensure data is secure, and the meaning is unchanged during capture, storage and movement of the data.

As shown, communication model 130 further comprises a leadership group 133, which provides guidance to, and in some cases, has fiduciary control over the organization. Leadership 133 operates with a Data Governance Council 135, which ensures compliance by an IT system in accordance with external regulations and internal objectives. Data Governance Council 135 may be chartered by Leadership 133 to meet compliance, data quality, and other business objectives through policy, standards, and like governance mechanisms. It will be appreciate that leadership group 133 and data governance council 135 may be an individual, group of individuals, a module, segment, or portion of code comprising one or more executable instructions for providing the associated function(s).

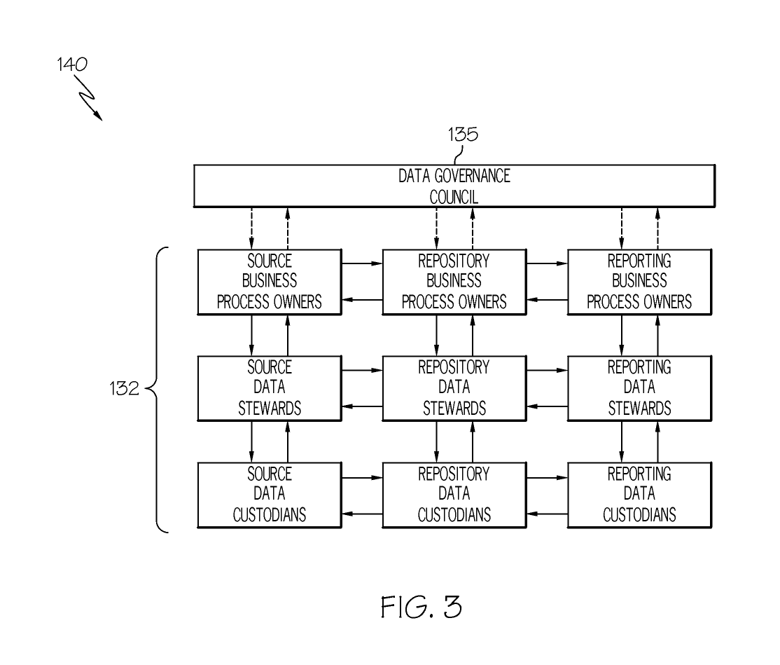

The fundamental information flow (Source to Repository to Reporting) illustrated by communication model 130 is aligned sequentially. This correlation between the information flow and the organization structure forms the basis of a 3×3 matrix structured communications model 140, as shown in FIG. 3. Communication model 140 defines a set of communication flows (shown as arrows between DGS 132) to adjacent, upstream, or downstream stakeholders for each of a set of DGS 132. Upon the receipt of a request to analyze business data of a business process, a set of functional roles are assigned to each DGS 132 to analyze the business according to communication model 140, as will be described in further detail below.

Communication model 140 provides structure to the communication between business and IT stakeholders of business critical data, ensuring streamlined, complete, and efficient responses to data governance requests. This satisfies the need for efficient and comprehensive collaboration laterally among peer roles and vertically between leadership and knowledge roles, while also operating, updating and maintaining business processes and the underlying business data. Furthermore, as there are a limited number of functional roles, there are a finite number of communication channels that are modeled and expressed as a repeatable well-defined process. The repeatable and structured process ensures all the functional roles for each DGS 132 are identified and achieved.

Structured communication model 140 is used as the foundation to optimize the use of software tools, which are applied to manage data throughout the information supply chain. Communication model 140 process activities integrate into common change control and auditing methodologies commonly used by organizations with IT systems. For example, object-oriented methodologies enable the automation of data governance best practices whereby: each data governance role can be seen as an intelligent agent, each intelligent agent (IA) has a clearly defined interface/function (i.e., the activity process flows), and the interface signature can be defined by the inputs and outputs of each process flow activity.

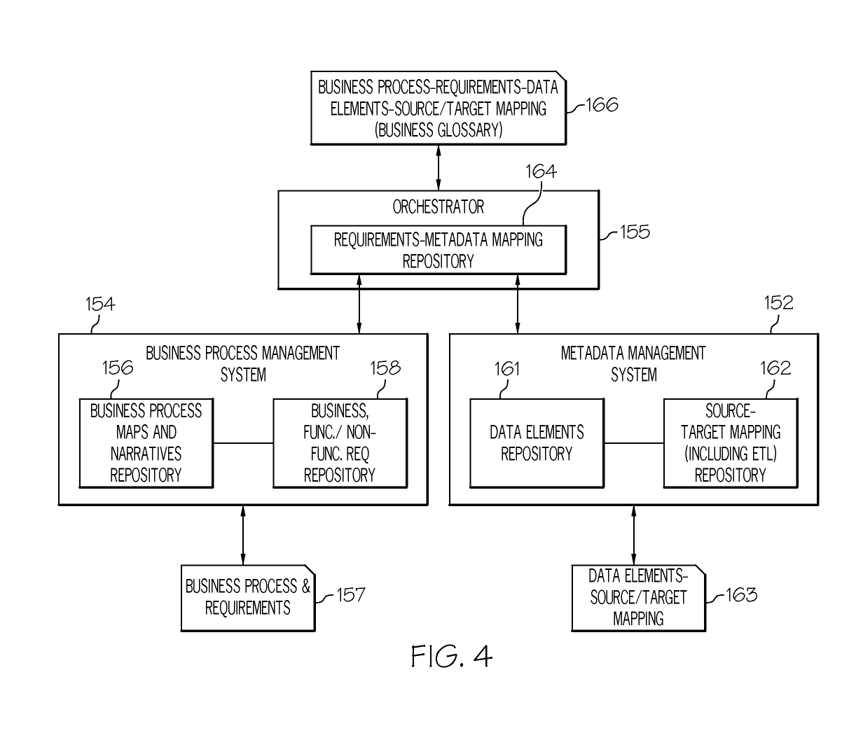

The IA and associated interfaces provide the foundational objects to enable the automation of data governance process flows, as shown in FIG. 4. The automation of process workflows can be achieved through the implementation of orchestrator 155, which may comprise a finite-state machine application responsible for executing the workflows. Orchestrator 155 is a stateful application, i.e., capable of keeping track of IA activities and enabling its agent and/or end-users to be directed to the appropriate user interface (i.e., internal or external) to complete the current and future activities and workflows.

For example, consider an impact analysis (i.e., an analysis request) process workflow implemented through a workflow application in which each end-user fulfills a specific data governance role (i.e., the end-user is the Intelligent Agent.) In this embodiment, after successfully verifying credentials, orchestrator 155 automatically directs the end-user (e.g. a source data steward) to be presented with a list of impact analyses. The source data steward selects an impact analysis uniquely identified by an identifier and description. Orchestrator 155 then presents the activity to be performed. By selecting the activity to be performed, orchestrator 155 launches a user interface (not shown) of an internal or external application. In one example, orchestrator 155 may call a requirement application, such as the IBM Rational® RequisitePro®, to identify from the requirements the impacted source data elements. (Rational® and RequisitePro® are registered trademarks of International Business Machines Corp. in the United States, other countries, or both.) Next, orchestrator 155 may call a metadata management system 152 (e.g., IBM InfoSphere® Information Server) to identify the impacted downstream repository data movements. (IBM InfoSphere® is a registered trademark of International Business Machines Corp. in the United States, other countries, or both.) Once the activity is completed, orchestrator 155 marks the activity completed and automatically initiates the downstream activity in the workflow.

As shown, orchestrator 155 operates with a legacy or non-legacy Business Process Management System 154 and a legacy or non-legacy Metadata Management System 152. Business Process Management System 154 enables business process maps and narratives to be defined from a Business Process Maps and Narratives Repository 156, while associated business, functional and non-functional requirements are defined from Business Functional/Non-Functional Requirements repository 158. This enables the creation of a Business Process & Requirements work product 157, thus allowing the lineage from business process to requirements.

Metadata Management System 152 enables both business and technically defined data elements from Data Elements Repository 161, as well as the data movements (i.e., source-target mapping) from Source-Target Mapping Repository 162, which describe the movements from a source system to a reporting system through well-defined data transformation (ETL). Metadata Management System 152 enables the creation of a Data Elements-Source & Target Mapping work product 163 linking data elements with the source-target mapping information, thus allowing the lineage between data elements and source, repository and reporting systems.

Orchestrator 155 links both Business Process Management System 154 (and associated repositories) with the Metadata Management System 152 (and associated repositories) through a Requirements—Metadata Mapping Repository 164. Requirements-Metadata Mapping Repository 164 is maintained and managed through Orchestrator 155. A user interface (not shown) enables the lineage from business processes to actual IT systems, thereby enabling both business and technical users to have complete capability to perform impact analysis and root cause analysis starting, respectively, from a source business process and ending with a reporting business process. The work product created by orchestrator 155 in the example shown in FIG. 4 can be referred to as a business glossary 166, which links business process, requirements, data elements, source system (system, database, table, field), data transformations (ETL) and reporting systems (system, database, table and field). As illustrated, orchestrator 155 streamlines and enables automation of business glossary 166 management and business process management. It further provides for better traceability from source business processes to downstream reporting business processes, better traceability from business reports to the source data, ensures consistent usage of critical business data elements, and improves transparency and trust of reported information.

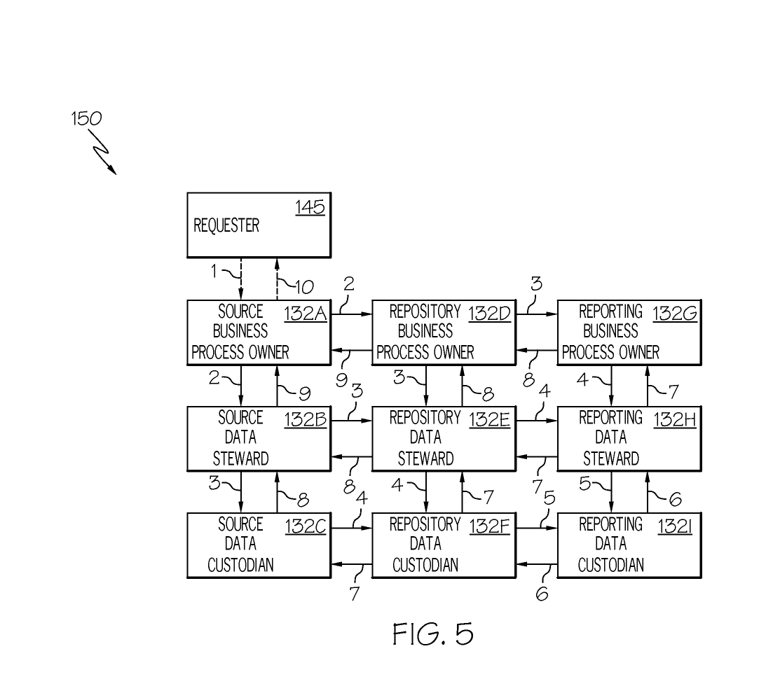

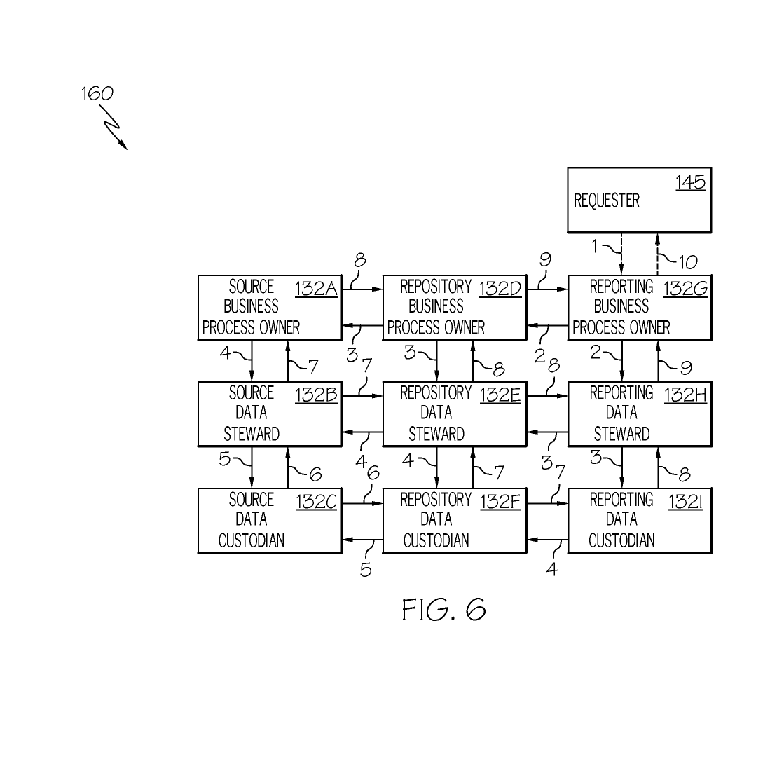

Turning now to FIGS. 5-6, various communication models and methods for structuring communication to automate data governance will be described in greater detail. Although non-limiting, the following use cases represent possible applications of the structured communication models according to embodiments of the invention. In a first case, shown in FIG. 5, communication model 150 is structured to perform an impact analysis to identify the impacts of a change (new or existing) to a source business process on the downstream repository and reporting processes. Communication model 150 defines a communication flow (represented by numerals 1-10) to adjacent (e.g., upstream, and downstream) stakeholders. As shown, communication model 150 defines DGS 132A-I as a structured 3×3 matrix.

In this embodiment, an organization may want to provide a new service or enhance an existing business process to satisfy a customer's evolving needs or gain insight into its customer's preferences. A requester 145 (e.g., program or project manager, supported by the data governance office) initiates an impact analysis to investigate the potential impacts/changes of a proposed enhancement or new business process to the data architecture using business glossary 166 (FIG. 4). Requester 145 ensures that the required DGS 132A-I are identified and communicate based on communication model 150.

In this example, Requester 145 requests a Source Business Process Owner 132A to conduct an impact analysis for a specific change request. Source Business Process Owner 132A works closely with a Source Data Steward 132B to identify the impacted/new source business process(es) and underlying business critical data element(s), and associated validation rule(s). Source Business Process Owner 132A identifies the downstream repository process(es) and activities and informs a Repository Business Process Owner 132D. Further, Source Data Steward 132B validates the new/impacted source data element(s) and communicates the information to a Source Data Custodian 132C. Repository Business Process Owner 132D analyzes the new/impacted Source Business process(es) and activities and identifies downstream repository processes and activities. Repository Business Process Owner 132D then informs a downstream Reporting Business Process Owner 132G. Repository Business Process Owner 132G also informs a Reporting Data Steward 132H. At the same time, Source Data Steward 132B engages the downstream Repository Data Steward 132E for assistance and guidance. Reporting Business Process Owner 132G informs Reporting Data Steward 132H of possible impacts on existing reports due to the submitted change request, while Repository Data Steward 132H analyzes the new/impacted repository data element(s) and informs a Repository Data Custodian 132F of potential impacts on the repository data systems and Data Movement Events. As used herein, a Data Movement Event refers to an event in which data at rest in a storage medium is transmitted, moved, copied or transformed via any medium to another separate storage medium including, but not limited to, batch processing of data from a customer facing transaction system to a centralized data warehouse, copying a data file of any type from one system to another, or merging of data from two separate systems where the data is combined using an algorithm and stored as a result of the algorithm.

Repository Data Steward 132E also communicates laterally with Reporting Data Steward 132H to consider additional potential impacts on the repository systems (e.g., impacts on the definition of data quality metrics). Source Data Custodian 132C identifies the new/impacted source systems, data tables, and fields, and communicates laterally with Repository Data Custodian 132F using the identified source data fields. Reporting Data Steward 132H further analyzes the impacted reports, identifying potential changes on the reporting data models, elements, and validation rules and data quality metrics. Reporting Data Steward 132H then communicates vertically the information to Reporting Data Custodian 132I to identify suggest, as need be, changes to the repository Data Movement Events to fully comply with the request. Repository Data Custodian 132I works closely with both Source Data Custodian 132C and Reporting Data Custodian 132I to fully vet and validate the impacts of the submitted change request on the Data Movement Events. Reporting Data Custodian 132I documents the changes to the reporting systems (tables, fields, and loading processes) and provides its analysis report to Reporting Data Steward 132H and Repository Data Custodian 132I. Lastly, Source Business Process Owner 132A closes the loop with Requester 145, who reviews, validates, and documents the impact analysis report. As implemented, each DGS 132A-I reviews the information provided by its downstream stakeholders and, if needed, modifies and validates the conducted impact analysis report.

Referring now to FIG. 6, another exemplary use case is shown and described. In this case, structured communication model 160 is configured to conduct a root cause analysis, e.g., investigate a data quality issue or access control issue. Again, communication model 160 defines the communication flow (represented by numerals 1-10) to adjacent (e.g., lateral and vertical) stakeholders. Similar to the previous use case, Reporting Business Process Owner 132G is configured to perform the following: work with Reporting Data Steward 132H to identify the data elements in use by the named report; identify all the upstream DGS of these data elements from Repository Business Process Owner 132D, Data Steward 132E, and Data Custodian132F to Source Business Process Owner 132A, Data Steward 132B and Data Custodian 132C; ensure that all involved DGS communicate in a timely and efficient manner to investigate the data quality or access control issue; ensure that all involved DGS are provided by their adjacent stakeholders with the necessary information to successfully perform their roles in this root cause analysis; keep track of any issues or decisions made during the course of root cause analysis; and ensure the accuracy, precision and completeness of the analysis report to, ultimately, identify and address the root of the problem.

As shown FIG. 6, Requester 145 (Program, Project, Organization, etc.) requests Reporting Business Process Owner 132G to conduct a root cause analysis for a set of reports. Reporting Business Process Owner 132G analyzes the reports to be analyzed, and identifies the associated reporting business processes and activities. Reporting Business Process Owner 132G then communicates vertically with Reporting Data Steward 132H to perform an upstream analysis of named reports. In parallel, Reporting Business Process Owner 132G notifies the upstream Repository Business Process Owner 132D, ensuring proper lateral communication.

Next, Reporting Data Steward 132H reviews the processes to analyze and determine the reporting data model and elements used on the named reports. Once identified, Repository Data Steward 132E works with Repository Data Custodian 132F to further analyze the systems and data elements required to be analyzed. Additionally, Reporting Data Steward 132H determines and communicates laterally with Repository Data Steward 132E, which represents the upstream reporting, data transformation, model, and elements.

While Reporting Data Steward 132H begins to involve both Reporting Data Custodian 132I and Repository Data Steward 132E, the notified Repository Business Process Owner 132D reviews and validates the analysis provided by Reporting Business Process Owner 132G on the upstream repository business processes to be audited. Repository Business Process Owner 132D furthers the root cause analysis by identifying the upstream source business processes and activities and notifies the related Source Business Process Owner 132A. Repository Business Process Owner 132D also informs Repository Data Steward 132E about the repository processes and associated data movements that need to be analyzed. Reporting Data Custodian 132I reviews the information provided by Reporting Data Steward 132H and works with Repository Data Custodian 132F to analyze the data elements and underlying data quality metrics to identify the potential root of a given problem.

While Reporting Data Custodian 132I starts interacting with Repository Data Custodian 132F, Repository Data Steward 132E also provides directions/inputs on the Data Movement Events to be further analyzed, ensuring the root cause analysis is complete. In particular, Repository Data Steward 132E provides a comprehensive list of upstream and downstream Data Elements and Data Movement Events to be analyzed. In parallel, Source Data Steward 132B is informed by Source Business Process Owner 132A of source processes and activities to be analyzed. At the same time, Source Data Steward 132B assists Repository Data Steward 132E to identify the source data elements and validation rules required to be analyzed to comply with the submitted root cause analysis.

After receiving the repository data elements and data movement events to be analyzed as well as the reporting data elements and data quality metrics, Repository Data Custodian 132F works with the upstream Source Data Custodian 132C to finalize the root cause analysis of repository data movement events and helps Source Data Custodian 132C to ensure the analysis is complete by identifying the source data systems, tables, and fields to verify and validate. Source Data Custodian 132C completes the root cause analysis by examining the source systems, data tables, fields and associated data elements and validation rules. Source Data Custodian 132C then reports the findings on the source data systems vertically to Source Data Steward 132B and laterally to Repository Data Custodian 132F.

Next, Source Data Steward 132B reviews the findings of Source Data Custodian 132C and reports to both Source Business Process Owner 132A and Repository Data Steward 132E. In parallel, Repository Data Custodian 132F reviews Source Data Custodian 132C findings, and completes the root cause analysis, reporting on the repository data movement events and data elements to Repository Data Steward 132E and Reporting Data Custodian 132I.

Source Business Process Owner 132A reviews Source Data Steward's 132B findings and closes the loop with Repository Business Process Owner 132D, providing a report on the analyzed business processes and activities along with the related findings. Repository Data Steward 132E receives inputs from both Source Data Steward 132B and Repository Data Custodian 132F, and ensures the completeness and consistency of the root cause analysis report.

Repository Data Steward 132E then reports vertically to Repository Business Process Owner 132D on reporting data elements, activities, and processes. Additionally, Repository Data Steward 132E also communicates laterally with Reporting Data Steward 132H on the analyzed data transformation, model, elements validation rules. Meanwhile, Reporting Data Custodian 132I reviews the report provided by Repository Data Custodian 132F and reports any findings to Reporting Data Steward 132H on the data elements and loading process.

Repository Business Process Owner 132D reviews the findings provided by both Source Business Process Owner 132A and Reporting Data Steward 132H. Repository Business Process Owner 132D ensures the completeness and consistency of the provided root cause analysis reports and submits a consolidated report to Reporting Business Process Owner 132G.

Finally, Reporting Business Process Owner 132G reviews and validates the root cause analysis report, ensuring accuracy, precision, completeness and documentation of reports, and provides the final root cause analysis report to requester 145. As appropriate, any identified issue(s) is logged as a future change request to be further analyzed, i.e., the root cause analysis could identify a problem to be submitted at a later time as a change request to be vetted and validated through the impact data governance analysis.

Referring again to FIG. 5, another exemplary use case will be described. In this embodiment, structured communication model 150 is configured to design and develop changes to a business glossary management system for a particular change request. This use case follows the same communication paths as the first use case, the difference being the content of the message communicated between each DGS 132. In this embodiment, Requester 145 works with the Source, Repository and Reporting Business Process Owners, Data Stewards, and Data Custodians to implement the required changes to the Business Glossary Management. That is, requester 145 works with the 9 identified and mapped DGS 132A-I (i.e., source, repository, Reporting Business Process Owner 132G, data steward(s) and data custodian(s)) to design and develop the end-to-end business glossary changes satisfying the requesters requirements, and allowing the complete lineage between business processes and data fields. Requester 145 also works with the Data Governance Office to ensure all the required Data Governance decisions and activities are properly conducted. If throughout the design/implementation of changes into the business glossary an issue is identified and cannot be addressed directly between the affected DGS, requester 145 works with the Data Governance Office to escalate and arbitrate any unresolved issue(s).

As described in the above examples, use cases, etc., the invention provides a structured communication model for managing information flow between defined DGS to provide an integrated workflow leveraging multiple data integration applications. The communication model defines the roles and responsibilities of each DGS, and governs information flow from a source application, through a shared data repository, and onward to multiple reporting environments. The process interacts with middle-ware to manage various aspects of metadata, such as the context and meaning of terms and data within systems, to enable automated data governance according to the communication model.

Furthermore, it can be appreciated that the approaches disclosed herein can be used within a computer system to structure communication for automated data governance, as shown in FIGS. 2 and 4. In this case, orchestrator 155 can be provided, and one or more systems for performing the processes described in the invention can be obtained and deployed to computer infrastructure 102. To this extent, the deployment can comprise one or more of (1) installing program code on a computing device, such as a computer system, from a computer-readable storage device; (2) adding one or more computing devices to the infrastructure; and (3) incorporating and/or modifying one or more existing systems of the infrastructure to enable the infrastructure to perform the process actions of the invention.

The exemplary computer system 104 may be described in the general context of computer-executable instructions, such as program modules, being executed by a computer. Generally, program modules include routines, programs, people, components, logic, data structures, and so on that perform particular tasks or implements particular abstract data types. Exemplary computer system 104 may be practiced in distributed computing environments where tasks are performed by remote processing devices that are linked through a communications network. In a distributed computing environment, program modules may be located in both local and remote computer storage media including memory storage devices.

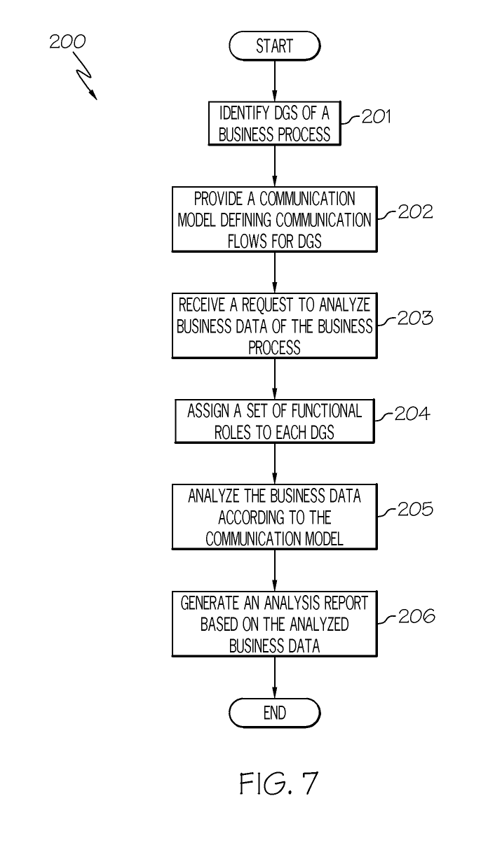

Computer system 104 carries out the methodologies disclosed herein, as shown in FIG. 7. Shown is a method 200 for structured communication to automate data governance, wherein a communication model defines the communication flows to adjacent stakeholders for each of the DGS. To accomplish this, at 201, DGS of a business process are identified. At 202, a communication model defines a set of communication flows to adjacent (e.g., upstream, downstream) stakeholders for each of the DGS. Next, at 203, a request to analyze business data of the business process is received. At 204, a set of functional roles for each DGS is assigned for analyzing the business data according to the communication model. Next, at 205, the business data is analyzed according to the communication model. Finally, an analysis report based on the analyzed business data is generated at 206, and the process ends.

The flowchart of FIG. 7 illustrates the architecture, functionality, and operation of possible implementations of systems, methods and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the blocks might occur out of the order noted in the figures. For example, two blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

Many of the functional units described in this specification have been labeled as modules in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. Modules may also be implemented in software for execution by various types of processors. An identified module or component of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Further, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, over disparate memory devices, and may exist, at least partially, merely as electronic signals on a system or network.

Furthermore, as will be described herein, modules may also be implemented as a combination of software and one or more hardware devices. For instance, a module may be embodied in the combination of a software executable code stored on a memory device. In a further example, a module may be the combination of a processor that operates on a set of operational data. Still further, a module may be implemented in the combination of an electronic signal communicated via transmission circuitry.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. The embodiments are not limited in this context.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values or symbols arranged in a predetermined syntax, that when executed, may cause a processor to perform a corresponding set of operations.

For example, an implementation of exemplary computer system 104 (FIG. 1) may be stored on or transmitted across some form of computer readable media. Computer readable media can be any available media that can be accessed by a computer. By way of example, and not limitation, computer readable media may comprise “computer storage media” and “communications media.”

“Computer-readable storage device” includes volatile and non-volatile, removable and non-removable computer storable media implemented in any method or technology for storage of information such as computer readable instructions, data structures, program modules, or other data. Computer storage device includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It is apparent that there has been provided an approach for structured communication for automated data governance. While the invention has been particularly shown and described in conjunction with a preferred embodiment thereof, it will be appreciated that variations and modifications will occur to those skilled in the art. Therefore, it is to be understood that the appended claims are intended to cover all such modifications and changes that fall within the true spirit of the invention.

What is claimed is:

1. A method for structuring communication to automate data governance, comprising the computer implemented steps of:
identifying a set of data governance stakeholders (DGS) of a business process;
providing a communication model defining a set of communication flows to adjacent stakeholders for each of the set of DGS;
receiving a request to analyze business data of the business process; and
assigning a set of functional roles to each of the DGS for analyzing the business data according to the communication model.

2. The method according to claim 1, further comprising analyzing the business data according to the communication model.

3. The method according to claim 2, further comprising generating an analysis report based on the analyzed business data.

4. The method according to claim 1, the receiving comprising receiving a request to perform at least one of the following: define a new data element, perform an impact analysis, perform a root cause analysis, and comply to an audit request.

5. The method according to 1, the providing further comprising defining the DGS of the communication model as a structured matrix.

6. The method according to claim 5, further comprising directing information in the structured matrix from a source stakeholder to a repository stakeholder to a reporting stakeholder.

7. A system for structuring communication to automate data governance, comprising:
a memory medium comprising instructions;
a bus coupled to the memory medium; and
a processor coupled to a data governance process orchestrator (DGPO) via the bus that when executing the instructions causes the system to:
identify a set of data governance stakeholders (DGS) of a business process;
provide a communication model defining a set of communication flows to adjacent stakeholders for each of the set of DGS;
receive a request to analyze business data of the business process; and
assign a set of functional roles to each of the DGS for analyzing the business data according to the communication model.

8. The system according to claim 7, further comprising instructions causing the system to analyze the business data according to the communication model.

9. The system according to claim 8, further comprising instructions causing the system to generate an analysis report based on the analyzed business data.

10. The system according to claim 7, further comprising instructions causing the system to analyze the business data by performing at least one of the following: defining a new data element, performing an impact analysis, performing a root cause analysis, and complying to an audit request.

11. The system according to claim 7, further comprising instructions causing the system to define the DGS in the communication model as a structured matrix.

12. The system according to claim 11, further comprising instructions causing the system to direct information in the structured matrix from a source stakeholder to a repository stakeholder to a reporting stakeholder.

13. A computer-readable storage device storing computer instructions, which when executed, enables a computer system to structure communication for automated data governance, the computer instructions comprising:
identifying a set of data governance stakeholders (DGS) of a business process;
providing a communication model defining a set of communication flows to adjacent stakeholders for each of the set of DGS;
receiving a request to analyze business data of the business process; and
assigning a set of functional roles to each of the DGS for analyzing the business data according to the communication model.

14. The computer-readable storage device according to claim 13 further comprising computer instructions for:
analyzing the business data according to the communication model; and
generating an analysis report based on the analyzed business data.

15. The computer-readable storage device according to claim 14 further comprising computer instructions for performing at least one of the following: generating an analysis report based on the analyzed business data. defining a new data element, performing an impact analysis, perform a root cause analysis, and complying to an audit request

16. The computer-readable storage device according to claim 13 further comprising computer instructions for defining the DGS of the communication model as a structured matrix.

17. The computer-readable storage device according to claim 16 further comprising computer instructions for directing information in the structured matrix from a source stakeholder to a repository stakeholder to a reporting stakeholder.

18. A computer-implemented method to structure communication for automated data governance, comprising:
providing a computer infrastructure being operable to:
define a communication model comprising a set of communication flows to adjacent stakeholders for each of a set of data governance stakeholders (DGS);
receive a request to analyze business data of the business process; and
assign a set of functional roles to each of the DGS for analyzing the business data according to the communication model.

19. The method according to claim 18, the computer infrastructure further operable to:
analyze the business data according to the communication model; and
generate an analysis report based on the analyzed business data.

19. The method according to claim 18, the computer infrastructure further operable to define the DGS of the communication model as a structured matrix.

20. The method according to claim 19, the computer infrastructure further being operable to direct information in the structured matrix from a source stakeholder to a repository stakeholder to a reporting stakeholder.
